(19) United States
(12) Patent Application Publication
(10) Pub. No.: US 2005/0288827 A1
(43) Pub. Date: Dec. 29, 2005

(54) Method and system for providing customer configuration of upload data sets in telematics systems

(75) Inventor: Gary A. Watkins, Royal Oak, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/875,879

(22) Filed: Jun. 24, 2004

(51) Int. Cl. G06F 17/00

(52) U.S. Cl. 701/1

(57) ABSTRACT

A method of providing a customer configuration to an upload data set from a telematics unit in a vehicle includes providing a configuration profile for the vehicle, receiving a service request and determining an action responsive to the service request and the configuration profile.

### FIELD OF THE INVENTION

This invention relates generally to a customer configuration of telematics systems. In particular, the invention relates to a method, computer usable medium and system for providing customer configuration to upload data sets of the telematics system.

### BACKGROUND OF THE INVENTION

The opportunity to personalize features in a mobile vehicle is ever increasing as the automobile is being transformed into a communications and entertainment platform as well as a transportation platform. Many new American cars will be installed with some type of telematics unit to provide wireless communication and location-based services. These services may be accessed through interfaces such as voice-recognition computer applications, touch-screen computer displays, computer keyboards, or a series of buttons on the dashboard or console of a vehicle.

Currently, telematics service call centers, in-vehicle compact disk (CD) or digital video display (DVD) media, web portals, and voice-enabled phone portals provide various types of location services, including driving directions, stolen vehicle tracking, traffic information, weather reports, restaurant guides, ski reports, road condition information, accident updates, street routing, landmark guides, and business finders.

For example, traffic and driving directions may be accessed through a voice portal that uses incoming number identification to generate location information responsive to the area code or prefix of the phone number, or to access location information stored in a user's profile associated with the phone number. Users may be prompted to enter more details through a voice interface. Other examples are web and wireless portals that offer location-based services such as maps and driving directions where the user enters both a start and end addresses. Some of these services may have a voice interface.

Some services provided by an advisor at a call center are only dependent upon knowing the users name. For example, if a user requests the advisor at a call center to set up a restaurant reservation as part of a concierge service, the user's name is required but not the user's location. In this case a user may want their location to be kept private, however the advisor will automatically have the location data available along with the name of the user. Alternatively, when a user requests a location-based service, the advisor automatically has the user's name along with the location. Some users prefer to keep all the unnecessary inputs private.

There are occasions for the telematics system to perform a vehicle data upload to collect one or more data inputs from a vehicle. The user is not necessarily aware that a vehicle data upload is occurring. The telematics system is automatically updated with the user's name, vehicle location, vehicle direction of travel, vehicle speed as well as date and time during the vehicle data upload. A user may desire to prevent the telematics system from obtaining some or all of the data inputs during a vehicle data upload.

Currently, the telematics system is automatically provided with vehicle and user data, without regard to the privacy considerations of the user. When obtaining some telematics services, a user may desire privacy with the option to prevent the call center from receiving some data input, such as, for example, the vehicle location or speed of travel.

Other data sets that may be uploaded from a telematics unit include gas mileage, DTC codes, oil life status, odometer readings, personal calling status, or any other information transmitted over a vehicle network.

It is desirable, therefore, to provide a method, computer usable medium and system that overcomes the limitations described above.

### SUMMARY OF THE INVENTION

One aspect of the present invention provides a method of providing a customer configuration to an upload data set from a telematics unit in a vehicle. The method includes providing a configuration profile for the vehicle, receiving a service request and determining an action responsive to the service request and the configuration profile.

Another aspect of the present invention provides a system providing a customer configuration to an upload data set from a telematics unit in a vehicle. The system includes means for providing a configuration profile for the vehicle, means for receiving a service request and means for determining an action responsive to the request and the configuration profile.

A third aspect of the present invention provides a computer readable medium storing a computer program for providing a customer configuration to an upload data set from a telematics unit in a vehicle. The computer readable medium storing a computer program includes computer readable code for providing a configuration profile for the vehicle, computer readable code for receiving a service request and computer readable code for determining an action responsive to the request and the configuration profile.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments, of the present invention are illustrated by the accompanying figures, wherein:

FIG. 1 is a schematic diagram of a one embodiment of a system for providing access to a telematics system in a mobile vehicle in accordance with the instant invention;

FIG. 2 illustrates a flowchart representative of providing a configuration profile in accordance with the present invention;

FIG. 3 illustrates a Table 1 representative of an exemplary selected setting in accordance with the present invention;

FIG. 4 illustrates a flowchart representative of providing a customer configuration in accordance with the present invention; and

FIG. 5 illustrates a flowchart representative of over-riding a configuration profile in accordance with the present invention.

### DETAILED DESCRIPTION OF THE PRESENTLY PREFERRED EMBODIMENTS

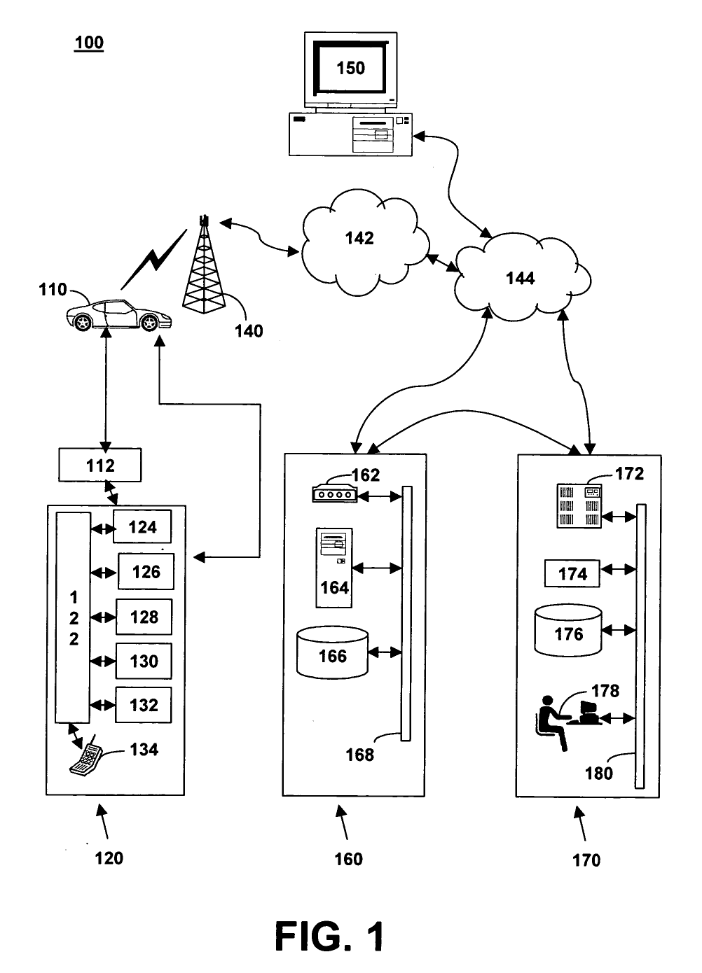

FIG. 1 illustrates one embodiment of a system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. Telematics unit 120 may include additional components not relevant to the present discussion.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

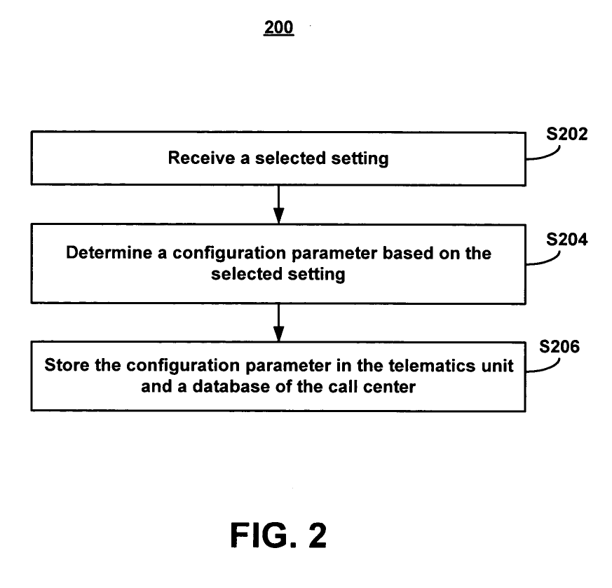

FIG. 2 illustrates a flowchart representative of providing a configuration profile in accordance with the present invention. In one embodiment, the customer configuration profile is a level of driver privacy for a vehicle. In this embodiment, the configuration profile is a driver privacy profile. The flowcharts in FIGS. 2, 4, and 5 are discussed for the exemplary case of driver privacy for a mobile vehicle 110. Other configuration profiles may be custom configured as described herein.

During stage S202, the call center 170 receives a selected setting from a subscriber to a mobile vehicle communication system (MVCS) 100. The setting is selected during the initiation of subscriber service, or at any time after initiation of service. In one embodiment, the selected setting comprises a plurality of first inputs associated with a respective plurality of second inputs. One of the plurality of first inputs is selected by the subscriber for each one of the plurality of second inputs available within the MVCS 100 for the telematics unit 120. In another embodiment, the selected setting comprises an overall input.

In the embodiment of configuring a driver privacy profile for a mobile vehicle 110, the call center 170 receives a selected privacy setting from a subscriber to a mobile vehicle communication system (MVCS) 100. A new subscriber provides the selected privacy setting upon initialization of MVCS 100 service for the telematics unit 120. In an alternative embodiment, a current subscriber provides the driver privacy profile at any time after service begins.

The selected privacy setting comprises a plurality of privacy level inputs associated with a respective plurality of service type inputs. One of the plurality of privacy levels inputs is selected by the subscriber for each one of the plurality of service type inputs offered by the MVCS 100 for the telematics unit 120.

The privacy level inputs include, for example, location anonymous, subscriber anonymous, vehicle anonymous, total anonymous and full information. A “location anonymous” input indicates that the subscriber's location will be anonymous to the call center 170. Similarly, a “subscriber anonymous” setting indicates that the identity of the subscriber will be anonymous to the call center, while a “total anonymous” setting indicates that the location and identity of the subscriber will by unknown to the call center. A “full information” setting indicates that the call center will have access to the subscribers name and location.

The service types inputs include emergency services and non-emergency services. In an emergency situation the call center often requires location and subscriber inputs to deliver desired services, so, in one embodiment, the subscriber is not permitted to select location anonymous, subscriber anonymous, total anonymous for any of the emergency services offered by the MVCS 100 service. The emergency services include collision detection, airbag deployment, theft-notification and alarm activation.

The non-emergency service type inputs include, for example, maintenance and diagnostics, various types of location services, including driving directions, traffic information, weather reports, restaurant guides, road condition information, accident updates, street routing, landmark guides, and business finders. The identity and location of the subscriber may be less important to the call center to assure delivery of such non-emergency services, and therefore, in one embodiment, the MVCS offers a greater level of anonymity to subscribers who desire such services.

The nature of some services requires that the choice of privacy level inputs is restricted. For example, if a subscriber requests driving directions the call center 170 may need to know the location of MVCU 110 in order to provide the desired service. In one embodiment, the call center may offer the subscriber a chance to allow the location to be illustrated despite pre-existing settings. In another exemplary situation, if a subscriber requests concierge service to set up a restaurant reservation, the call center 170 must know certain aspects of the subscriber's identity, such as name, location, etc. in order to provide that service.

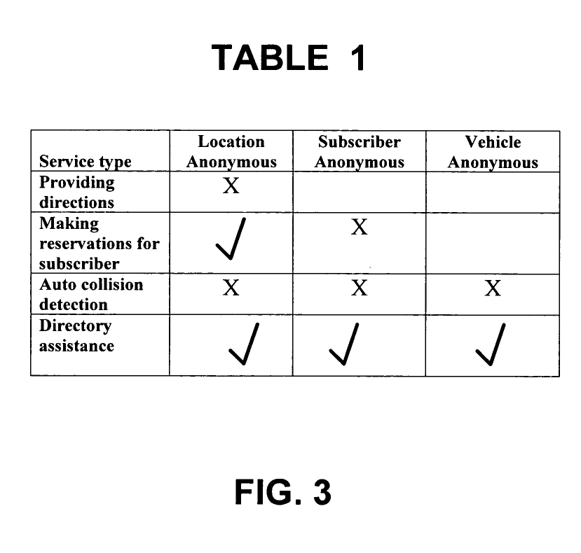

FIG. 3 illustrates a Table 1 representative of an exemplary selected setting, such as a privacy level, in accordance with the present invention. Table 1 shows an exemplary portion of a table that a subscriber uses to select a privacy setting. The top row lists the selectable first inputs or privacy level inputs, which include location anonymous, subscriber anonymous and vehicle anonymous. In this exemplary table, the first column lists a few respective second inputs or service type inputs available on the MVCS 100. During the selection of a privacy setting, all the second inputs or service type inputs available to the subscriber of the MVCS 100 are listed in the first column. In one embodiment, there are additional selectable first inputs or privacy level inputs.

Each box in the Table 1 relates to a privacy level/service type combination input. For each box the privacy level input is indicated at the top of the column in which the box is located and the respective service type input is indicated at the beginning of the row in which the box is located. An X is in the boxes for privacy level/service type combination inputs that the subscriber is not permitted to select. The subscriber places a check in the boxes for the desired privacy level/service type combination inputs when selecting a privacy setting. In one embodiment, the subscriber verbally selects the privacy settings with an advisor 178, who enters the privacy settings into the MVCS 100 for the subscriber.

As illustrated in Table 1, the subscriber chooses to have the vehicle location remain anonymous at the call center 170 when the subscriber requests the call center 170 to make a reservation. The subscriber will allow the call center 170 to have access to the vehicle information when a reservation is made. The exemplary subscriber has selected total anonymous privacy level input during directory service by checking all the boxes in the row labeled directory assistance. Thus, when the subscriber requests directory assistance, the call center 170 will have no information about the subscriber's location, name or vehicle. The subscriber is prevented from keeping the vehicle location, subscriber name or vehicle information from the call center 170 when the call center 170 receives an auto collision detection signal for the subscriber's mobile vehicle 110.

In one embodiment, the privacy setting comprises an overall privacy level input. In this embodiment, the user selects to put a check in all the boxes in Table 1 that do not contain an X.

In another embodiment, the subscriber selects a complete-privacy setting in which location anonymous, subscriber anonymous and vehicle anonymous is selected for all non-emergency services. A complete-privacy setting selection prevents the use of many of the services offered by the MVCS 100, but the subscriber is permitted to override the selected privacy setting as desired for non-emergency services.

In one embodiment, the selection of privacy setting is responsive to broad contact types, such a button-initiated requests at the telematics unit 120 and non-subscriber-initiated services rather than being responsive to the specific reason the call was initiated.

Non-subscriber-initiated services occur when the call center 170 requests a vehicle data upload from telematics unit 120 of MVCU 110. Non-subscriber-initiated services include retrieval of maintenance records for service and traffic probes to get speed and direction of travel from mobile vehicle 110 to create a traffic flow data profile at the call center 170. The subscriber can choose to prevent non-subscriber-initiated vehicle data uploads for non-emergency services. Alternatively, the subscriber can choose to permit retrieval of the minimal amount of data and information during non-emergency non-subscriber-initiated vehicle data uploads. Thus, a subscriber will allow a traffic probe input to be retrieved by the call center 170 without the subscriber's information and without some of the vehicle information, such as vehicle make, model and year.

In one embodiment, the available second inputs or service type inputs are listed on the top row of the privacy setting selection table and the selectable first inputs or privacy level inputs are listed in the first column.

Returning to FIG. 2, during stage S202, communications service manager 174 transmits the selected settings to processor 122. In one embodiment, the selected settings are received at the telematics unit 120 from the subscriber and are transmitted from the telematics unit 120 to the communications service manager 174 in the call center 170.

In the exemplary case of providing driver privacy for a mobile vehicle 110, during stage S202, the inputs for the selected privacy settings are received by the communications service manager 174 in the call center 170 and transmitted to the processor 122 in the telematics unit 120. Alternatively, the embodiments described above apply to this exemplary case.

During stage S204, the processor 122 determines a configuration parameter responsive to the selected settings and transmits the configuration parameter to the communications service manager 174 in the call center 170. In another embodiment, the communications service manager 174 determines a configuration parameter responsive to the selected settings and transmits the configuration parameter to the processor 122. In one embodiment, communications service manager 174 and processor 122 each determine a configuration parameter responsive to the selected settings. If a subscriber selects new settings, the processor 122 determines a new configuration parameter responsive to the selected settings and transmits the new configuration parameter to the communications service manager 174.

In the exemplary case of providing driver privacy for a mobile vehicle 110, during stage S204, the processor 122 determines a configuration parameter responsive to the selected privacy settings and transmits the configuration parameter to the communications service manager 174. Alternatively, the embodiments described above apply to this exemplary case.

During stage S206, the configuration parameters are stored in the memory 128 of telematics unit 120 and in the communications services database 176 in the call center 170. In another embodiment, the configuration parameters are only stored in the memory 128 of telematics unit 120.

The processor 122 uses the configuration parameter to modify signal-transmitting software in the telematics unit 122. The modified signal-transmitting software automatically modifies signals transmitted from the telematics unit 120 to reflect the selected setting.

In the exemplary case of providing driver privacy for a mobile vehicle 110, during stage S206, the modified signal-transmitting software automatically modifies signals transmitted from the telematics unit 120 to reflect a level of privacy responsive to the selected privacy setting. The modified signal-transmitting software is a computer program stored in a computer readable medium.

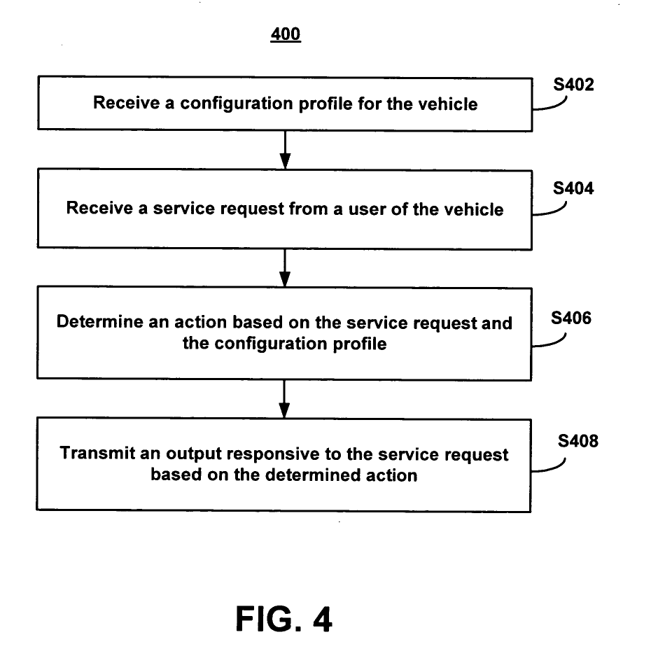

FIG. 4 illustrates a flowchart 400 representative of providing a customer configuration in accordance with the present invention. During stage S402, a configuration profile for the MVCU 110 is received as described in flowchart 200 of FIG. 2. The customer configuration comprises the selected setting and the determined configuration parameters.

In the exemplary case of providing driver privacy for a mobile vehicle 110, during stage S402, the driver privacy profile for a mobile vehicle 110 comprises the selected privacy setting and the determined configuration parameters.

During stage S404, the call center 170 receives a service request from the user of the MVCU 110. A signal for a user-initiated request is received at the call center 170 by a communications service advisor 178. The user-initiated request signal is transmitted from the telematics unit 120 after the processor 122 modified the signal to encode the configuration profile selected by the subscriber in the setting. The modification is responsive to the configuration parameters. In one embodiment, the configuration profile is encoded in the header of the signal.

In one embodiment, the service request is non-subscriber-initiated. In that case, during stage S402, the service request signal is received at the telematics unit 120. The processor 122 operates on the received signal according to the software in memory 128, which was modified by the configuration parameters.

In the embodiment of providing a configuration for driver privacy, during stage S402, the user-initiated request signal is transmitted from the telematics unit 120 after the processor 122 modified the signal to encode the privacy level inputs selected by the subscriber in the privacy setting. The signal transmitted from the telematics unit 120, in one embodiment, has a GPS field for the GPS settings, a subscriber identification (SID) field for the subscriber electronic identification and a vehicle identification (VID) field the vehicle identification. The GPS field, the SID field and the VID field are null if the privacy profile requires location anonymous, subscriber anonymous and vehicle anonymous privacy levels, respectively. In one embodiment, there are additional signal fields related to the driver privacy.

For example, if a subscriber elected to have location anonymous privacy level input for a concierge service, the signal for a concierge service request is transmitted with a null GPS field on the signal. If a subscriber elected to have location anonymous, subscriber anonymous and vehicle anonymous privacy level inputs for directory assistance, the signal for a directory request is transmitted with a null GPS field, null SID field and null VID field.

During stage S406, an action is determined responsive to the service request and the configuration profile. For a user-initiated request the communications services manager 174 in the call center 170 receives the request with the signal fields modified for selected setting responsive to the configuration profile. In one embodiment, the fields in a signal are modified and the action for the service request is MODIFY OPERATION. In one embodiment, none of the required fields in a signal are modified by the configuration parameter and the action for the service request is NORMAL OPERATION. In one embodiment, one or more of the required fields in a signal is null and the action for the service request is REJECT. The labels, such as, MODIFY OPERATION, NORMAL OPERATION and REJECT, are responsive to the nature of the configuration profile and the intended use for such a configuration profile and, thus, other labels are used as appropriate.

For a vehicle data upload request the processor 122 in telematics unit 120 determines what action to take in response to the vehicle data upload request and responsive to the stored configuration profile.

In the exemplary case of providing driver privacy for a mobile vehicle 110, during stage S406, a privacy action is determined responsive to the service request and the driver privacy profile.

For a user-initiated request the communications services manager 174 in the call center 170 receives the request with the signal fields modified for selected privacy level inputs responsive to the driver privacy policy. If the required fields in a signal are not null, the privacy action for the service request is PROCEED. If one or more of the required fields in a signal is null, the privacy action for the service request is REJECT. In another embodiment, other labels for the privacy action are used.

For a vehicle data upload request the processor 122 determines what privacy action to take in response to the vehicle data upload request. If the subscriber elected to block all vehicle data upload requests, the privacy action for the non-subscribed initiated service request is REJECT. If the subscriber elected to provide the minimal amount of data and information during non-emergency non-subscriber-initiated vehicle data uploads, the privacy action is MODIFY OPERATION.

In one embodiment, the call center 170 recognizes that the subscriber elected to block all vehicle data upload requests responsive to the configuration parameters stored in the communication services databases 176. In that case, the vehicle data upload request is not sent to that subscriber.

During stage S408, an output responsive to the service request and responsive to the determined action is transmitted. One output responsive to the service request is a provision of modified service when the determined action is MODIFY OPERATION. The output responsive to the service request is a denial of service if the determined action is REJECT. The denial of service is transmitted to the initiator of the request. The request initiator is the subscriber for subscriber-initiated service requests and the call center 170 for non-subscriber initiated requests. If the action for the service request is NORMAL OPERATION, the output response to the service request is a normal output response.

During stage S408, an output responsive to the service request and responsive to the determined privacy action, in one embodiment, is transmitted. One output responsive to the service request is a provision of service. The requested service is provided to the user when the determined privacy action is PROCEED or MODIFY OPERATION. The output responsive to the service request is a denial of service if the determined privacy action is REJECT. The denial of service is transmitted to the initiator of the request. The request initiator is the subscriber for subscriber-initiated service requests and the call center 170 for non-subscriber initiated requests.

If the subscriber elected to provide the minimal amount of data and information during non-emergency non-subscriber-initiated vehicle data uploads, the MODIFY OPERATION action is taken by the processor 122 in telematics unit 120, which transmits signals having nulls in the appropriate fields in response to the vehicle data upload request.

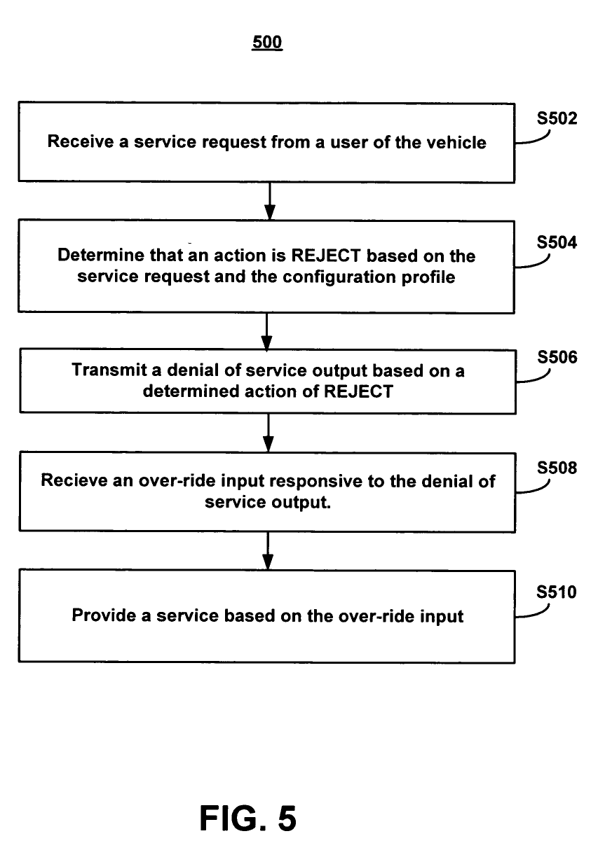

FIG. 5 illustrates a flowchart 500 representative of over-riding the configuration profile in accordance with the present invention. The embodiment illustrated in FIG. 5 relates to configurations of a driver privacy setting. During stage S502, the call center 170 receives a request from the user of an MVCU 110 as described for stage S404 in flowchart 400 of FIG. 4. During stage S504, it is determined that an action is REJECT responsive to the service request and the configuration profile as described above in stage S406 in flowchart 400 of FIG. 4.

During stage S506, the communication service manager 174 transmits a denial of service output to the user responsive to the determined action of REJECT. The denial of service is a message displayed on a visual display and/or audio device such as speakers 132.

During stage S506, the communication service manager 174 transmits a denial of service output to the user responsive to the determined privacy action of REJECT.

During stage S508, the call center 170 receives an over-ride input from the user of an MVCU 110 in response to the denial of service output. The user submits an over-ride input after receiving the denial of service output, in order to obtain the requested service without having to resubmit a new selected setting for a new configuration profile. In this way the user can decide, at selected times, to obtain services which would otherwise be blocked by the customer configuration.

Advisor 178 receives an over-ride from the user, either verbally, or from a user communication such as a text message, email, or other communication. In one embodiment, the user submits the over-ride input by submitted the same service request a second time within a predetermined period of time stored in the memory 128 and communication services databases 176. In this latter embodiment, the processor 122 responds to the second request by opening a communication channel between the user and advisor 178. The advisor then obtains a over-ride request from the user of the mobile vehicle 110. In an alternative embodiment, the over-ride request is a series of button pushes which are pre-programmed in the telematics unit 120 to be recognized as an over-ride request.

The user submits the over-ride input by placing a call to an advisor 178 in the call center 170 and verbally requesting the over-ride or by any of the above described embodiments.

During stage S510, the MVCS 100 provides the requested service responsive to the over-ride input. The telematics unit 120 sends a new service request signal with required data in all the required fields of the signal. The call center 170 responds by providing the requested service.

During stage S510, the new service request signal has nulls in the non-required fields, to protect the privacy of the subscriber as much as possible for the requested service.

While the embodiments, of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of providing a customer configuration to an upload data set from a telematics unit in a vehicle, the method comprising:
receiving a configuration profile for the vehicle;
receiving a service request; and
determining an action responsive to the service request and the configuration profile.

2. The method of claim 1, wherein receiving a configuration profile for the vehicle comprises:
receiving a selected setting;
determining a configuration parameter responsive to the selected setting;
storing the configuration parameter in the telematics unit; and
storing the configuration parameter in a database of a call center.

3. The method of claim 2, wherein the selected setting comprises a plurality of first inputs associated with a respective plurality of second inputs.

4. The method of claim 2, wherein the selected setting comprises an overall input.

5. The method of claim 1, wherein the received service request is transmitted from the telematics unit of the vehicle to a call center.

6. The method of claim 1, wherein receiving a service request comprises
sending a vehicle data upload request from a call center to the telematics unit of the vehicle.

7. The method of claim 1, further comprising:
transmitting an output responsive to the service request responsive to the determined action.

8. The method of claim 7, wherein the transmitted output comprises a denial of service output.

9. The method of claim 8, further comprising:
receiving an over-ride input responsive to the denial of service output.

10. The method of claim 1, wherein the configuration profile is a driver privacy profile having a selected privacy setting, and wherein the selected privacy setting comprises a plurality of privacy level inputs associated with a respective plurality of service types inputs.

11. A system providing a customer configuration to an upload data set from a telematics unit in a vehicle, the system comprising:
means for providing a configuration profile for the vehicle;
means for receiving a service request; and
means for determining an action responsive to the request and the configuration profile.

12. A computer readable medium storing a computer program for providing a customer configuration to an upload data set from a telematics unit in a vehicle comprising:
computer readable code for providing a configuration profile for the vehicle;
computer readable code for receiving a service request; and
computer readable code for determining an action responsive to the request and the configuration profile.

13. The medium of claim 12, wherein computer readable code for providing a configuration profile comprises:
computer readable code for receiving a selected setting;
computer readable code for determining a configuration parameter responsive to the selected setting;
computer readable code for storing the configuration parameter in the telematics unit; and
computer readable code for storing the configuration parameter in a database of a call center.

14. The medium of claim 12, wherein the selected setting comprises a plurality of first inputs associated with a respective plurality of second inputs.

15. The medium of claim 12, wherein the selected setting comprises an overall input.

16. The medium of claim 12, wherein computer readable code for receiving a service request comprises:
computer readable code for transmitting a vehicle data upload request from a call center to the telematics unit of the vehicle.

17. The medium of claim 12, further comprising:
computer readable code for transmitting an output responsive to the service request responsive to the determined action.

18. The medium of claim 17, wherein the transmitted output comprises a denial of service output responsive to the determined action.

19. The medium of claim 12, wherein the computer readable code for providing a configuration profile comprises
computer readable code for receiving a driver privacy profile having a selected privacy setting, wherein the selected privacy setting comprises a plurality of privacy level inputs associated with a respective plurality of service types inputs.
